(19) United States
(12) Patent Application Publication
(10) Pub. No.: US 2022/0312814 A1
(43) Pub. Date: Oct. 6, 2022

(54) NUTRITIONAL INGREDIENT WITH FLOW AND ANTIFOAM PROPERTIES

(71) Applicant: ABBOTT LABORATORIES, Abbott Park, IL (US)

(72) Inventors: Necla EREN, Columbus, OH (US); Timothy LAPLANTE, Powell, OH (US); Nalini PATEL, Plain City, OH (US); Normanella DEWILLE, Columbus, OH (US)

(21) Appl. No.: 17/616,457

(22) PCT Filed: May 28, 2020
(86) PCT No.: PCT/US2020/034792

§ 371 Date: Dec. 3, 2021

Related U.S. Application Data
(60) Provisional application No. 62/858,566, filed on Jun. 7, 2019.

(51) Int. Cl. A23L 29/00; A23L 33/16; A23L 33/00

(52) U.S. Cl. CPC A23L 29/015; A23L 29/05; A23L 33/16; A23L 33/40

(57) ABSTRACT

A nutritional ingredient for use in nutritional powders is provided. The nutritional ingredient is an agglomerated calcium source, which includes particles of a calcium source adhered together with a lecithin binder. The nutritional ingredient functions as both a flow agent and an antifoam agent when incorporated into nutritional powders, such as powdered infant formulas.

### CROSS-REFERENCE TO RELATED APPLICATIONS

This application claims priority to and the benefit of U.S. Provisional Patent Application No. 62/858,566, filed Jun. 7, 2019, the entire content of which is incorporated by reference herein.

### FIELD

The present disclosure relates to a nutritional ingredient for use in a nutritional powder. More particularly, the present disclosure relates to an agglomerated calcium source that functions as a flow agent and an antifoam agent and nutritional powders that include the agglomerated calcium source.

### BACKGROUND

Nutritional powders such as powdered infant formulas and powdered beverage products are widely used to provide primary, supplemental, or sole nutrition to the consumer. These nutritional powders are typically combined with a liquid, such as water, to render the nutritional powder suitable for oral consumption. However, many nutritional powders often exhibit poor flow behavior, which can manifest as powder clumping and make scooping or pouring the nutritional powder difficult. In addition, many nutritional powders produce excessive foam during reconstitution, which is generally not preferred by consumers.

### SUMMARY

Disclosed herein is a nutritional ingredient for use in nutritional powders. The nutritional ingredient provides a single solution to the problems of poor flowability and excessive foam generation during reconstitution of a nutritional powder. Methods of making the nutritional ingredient and nutritional powders are also disclosed herein.

In accordance with the present disclosure, a nutritional ingredient comprising an agglomerated calcium source is provided. The agglomerated calcium source comprises particles of a calcium source adhered together with a lecithin binder.

In accordance with the present disclosure, a nutritional powder is provided. The nutritional powder comprises a base powder comprising one or more of a protein, a fat, and a carbohydrate, and an agglomerated calcium source comprising particles of a calcium source adhered together with a lecithin binder. The nutritional powder exhibits excellent flowability and minimal foam generation during reconstitution.

### DETAILED DESCRIPTION

Disclosed herein is a nutritional ingredient and nutritional powders that include the nutritional ingredient. While the present disclosure describes certain embodiments of the nutritional ingredient and nutritional powders in detail, the present disclosure is to be considered exemplary and is not intended to be limited to the disclosed embodiments. Also, certain elements or features of embodiments disclosed herein are not limited to a particular embodiment, but instead apply to all embodiments of the present disclosure.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The nutritional ingredient and nutritional powders of the present disclosure can comprise, consist of, or consist essentially of the essential elements of the disclosure as described herein, as well as any additional or optional element described herein or which is otherwise useful in nutritional applications.

All percentages, parts, and ratios as used herein are by weight of the total composition unless otherwise specified. All such weights as they pertain to listed ingredients are based on the active level and, therefore, do not include solvents, by-products, or other components that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The term “about” as used herein means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by 10%.

The term “adult nutritional powder” as used herein refers to a nutritional powder suitable for generally maintaining or improving the health of an adult.

The term “infant” as used herein, unless otherwise specified, refers to a human about 36 months of age or younger. The term “toddler” as used herein, unless otherwise specified, refers to a subgroup of infant that is about 12 months of age to about 36 months of age. The term “child” as used herein, unless otherwise specified, refers to a human about 3 years of age to about 18 years of age. The term “adult” as used herein, unless otherwise specified, refers to a human about 18 years of age or older.

The term “infant nutritional powder” as used herein refers to a nutritional powder that has the proper balance of macronutrients, micro-nutrients, and calories to provide sole or supplemental nourishment for and generally maintain or improve the health of infants, toddlers, or both. Infant nutritional powders preferably comprise nutrients in accordance with the relevant infant formula guidelines for the targeted consumer or user population, an example of which would be the nutrient specifications for infant formula described in 21 C.F.R. § 107.100 (Apr. 1, 2018 edition).

The term “nutritional powder” as used herein, unless otherwise specified, refers to nutritional products that are solids or semisolids in the form of particles that are generally flowable or scoopable. A nutritional powder is usually reconstituted by addition of water or another liquid to form a liquid nutritional composition prior to administration to (e.g., providing to or consumption by) an individual.

The term “pediatric nutritional powder” as used herein refers to a nutritional powder suitable for generally maintaining or improving the health of toddlers, children, or both.

Any combination of method or process steps as used herein may be performed in any order, unless otherwise specified or clearly implied to the contrary by the context in which the referenced combination is made.

In one aspect of the present disclosure, a nutritional ingredient is provided. The nutritional ingredient according to the present disclosure is an agglomerated calcium source. The agglomerated calcium source comprises particles of a calcium source adhered together with a lecithin binder. The agglomerated calcium source of the present disclosure functions both as a flow agent and as an antifoam agent and, thus, provides dual functionality in a single ingredient. The term “agglomerated” as used herein refers to a powder that has been processed such that particles of the powder adhere together to form agglomerates with limited points of contact between the particles so that most (e.g., greater than 50%) of the surface area of the agglomerate is available to wetting.

A variety of calcium sources may be used to form the agglomerated calcium source of the present disclosure. In embodiments, the calcium source is selected from tricalcium phosphate, calcium citrate, calcium phosphate, dicalcium phosphate, calcium carbonate, and combinations thereof. A preferred calcium source used to form the agglomerated calcium source of the present disclosure is tricalcium phosphate.

In addition to a calcium source, the agglomerated calcium source of the present disclosure comprises a lecithin binder. The lecithin binder functions to adhere particles of the calcium source together when forming the agglomerated calcium source. In addition, the lecithin binder provides the agglomerated calcium source with antifoam functionality.

The lecithin binder generally comprises a lecithin. A variety of lecithins may be used in the lecithin binder to form the agglomerated calcium source of the present disclosure. In embodiments, the lecithin binder comprises a lecithin having a hydrophilic-lipophilic balance (HLB) of about 4 to about 12. As one of skill in the art will understand, the HLB value describes the tendency of an amphiphilic compound to be hydrophilic or lipophilic (hydrophobic). The HLB scale ranges from 1 to 20. A compound having a high HLB value (e.g., greater than or equal to 10) is generally more hydrophilic, whereas a compound having a low HLB value (e.g., less than 10) is generally more lipophilic.

Suitable lecithins for use in the lecithin binder include, but are not limited to, soy lecithins commercially available as SOLEC™ 152 (HLB≈4), SOLEC™ 162-US (HLB≈4), SOLEC™ HR-2B (HLB≈8), SOLEC™ E (HLB≈12), and SOLEC™ CA (HLB≈6) from Solae, LLC (St. Louis, Mo.). It is also contemplated that the lecithin binder may comprise a lecithin derived from a source other than soy such as, but not limited to, egg, sunflower seed, canola, cottonseed, or animal fat. Preferably, the lecithin binder comprises a soy lecithin.

In embodiments, the lecithin binder comprises a mixture of water and a lecithin. In embodiments, the lecithin binder comprises from 0 wt % to 90 wt % water and from 10 wt % to 100 wt % lecithin, based on the total weight of the lecithin binder. In embodiments, the lecithin binder comprises from 80 wt % to 90 wt % water and from 10 wt % to 20 wt % lecithin, based on the total weight of the lecithin binder. In embodiments, the lecithin binder comprises from 40 wt % to 60 wt % water and from 40 wt % to 60 wt % lecithin, based on the total weight of the lecithin binder. In embodiments, the lecithin binder consists essentially of a lecithin (i.e., no water is added to the lecithin ingredient, although the lecithin ingredient may contain some amount of inherent water, typically less than about 1% by weight).

The agglomerated calcium source of the present disclosure may comprise any one or more of the calcium sources and any one or more of the lecithin binders described above. In embodiments of the agglomerated calcium source of the present disclosure, the calcium source comprises tricalcium phosphate and the lecithin binder comprises a lecithin having an HLB of about 4 to about 12. In embodiments of the agglomerated calcium source of the present disclosure, the calcium source consists of tricalcium phosphate and the lecithin binder comprises a lecithin having an HLB of about 4 to about 12.

In embodiments, the agglomerated calcium source of the present disclosure comprises from 55 wt % to 99.5 wt % particles of the calcium source and from 0.5 wt % to 45 wt % lecithin binder, based on the total weight of the agglomerated calcium source. In embodiments, the agglomerated calcium source of the present disclosure comprises from 60 wt % to 99 wt % particles of the calcium source and from 1 wt % to 40 wt % lecithin binder, based on the total weight of the agglomerated calcium source. In embodiments, the agglomerated calcium source of the present disclosure comprises from 75 wt % to 99 wt % particles of the calcium source and from 1 wt % to 25 wt % lecithin binder, based on the total weight of the agglomerated calcium source. In embodiments, the agglomerated calcium source of the present disclosure comprises from 55 wt % to 75 wt % particles of the calcium source and from 25 wt % to 45 wt % lecithin binder, based on the total weight of the agglomerated calcium source. In embodiments, the agglomerated calcium source of the present disclosure comprises from 90 wt % to 99 wt % particles of the calcium source and from 1 wt % to 10 wt % lecithin binder, based on the total weight of the agglomerated calcium source.

Flowability is generally described as the ease with which a powder flows under specified conditions. The particle size of the agglomerated calcium source of the present disclosure is a parameter that affects the flowability of the agglomerated calcium source. In embodiments, the agglomerated calcium source has a mean particle size of 4.95 μm to 30 μm, including 5μm to 20 μm, 5.5 μm to 15 μm, and also including 5.75 μm to 10 μm. In embodiments, the agglomerated calcium source has an x90 particle size of 10 μm to 50 μm, including 10 μm to 45 μm, 10 μm to 35 μm, and also including 12 μm to 25 μm. The x90 particle size refers to the particle size at which 90% of the particles in a sample are smaller on a volume basis. Laser diffraction techniques may be used to measure the particle size and particle size distribution of the agglomerated calcium source of the present disclosure. The powder is dispersed into an air stream and passed through a laser beam.

In embodiments, the agglomerated calcium source of the present disclosure has a flow factor of 1.7 to 4, including 1.75 to 3, 1.8 to 2.75, and also including 1.9 to 2.5. Flow factor (or volume flowability) can be determined using any of the test methods suitable for the Brookfield Powder Flow Tester (Brookfield Engineering Laboratories, Inc., Middleboro, Massachusetts), including those provided in a Brookfield Powder Flow Tester manual such as Manual No. M09-1200-0O213. The Brookfield Powder Flow Tester measures the flow factor of the powder in dimensionless units of “ff.” Flow factor is defined as the ratio of major principal consolidating stress (x-axis) to unconfined failure strength (y-axis).

In embodiments, the agglomerated calcium source of the present disclosure has a loose bulk density of 0.35 g/cm³ to 0.7 g/cm³, including 0.35 g/cm³ to 0.65 g/cm³, 0.4 g/cm³ to 0.6 g/cm³, and also including 0.4 g/cm³ to 0.55 g/cm³. The loose bulk density can be measured by any of several industry standard methods, including, but not limited to, ASTM D6683-14, “Standard Test Method for Measuring Bulk Density Values of Powders and Other Bulk Solids as a Function of Compressive Stress,” and GEA Niro Analytical Method A 2 A, “Powder Bulk Density.” In embodiments, the agglomerated calcium source of the present disclosure has a skeletal density of 1.4 g/cm³ to 4 g/cm³, including 1.6 g/cm³ to 3 g/cm³, 1.7 g/cm³ to 2.9 g/cm³, and also including 1.8 g/cm³ to 2.8 g/cm³. The skeletal density can be measured using techniques known in the art, such as gas pycnometry.

The agglomerated calcium source of the present disclosure may be produced according to well-known processes, such as an agglomeration process or an instantization process. In embodiments of the present disclosure, the agglomerated calcium source may be produced using an agglomeration process. The agglomeration process comprises spraying a lecithin binder onto particles of a calcium source in a fluidized bed. As one of skill in the art will understand, in the agglomeration process, the particles of the calcium source are caused to become airborne in the fluidized bed by a fluidizing air stream and the airborne particles of the calcium source are sprayed with the lecithin binder. The outer surface of at least a portion of the airborne particles of the calcium source are partially covered with the lecithin binder, which functions to adhere particles of the calcium source together as they contact one another, thus forming the agglomerated calcium source. The particles of the calcium source and the lecithin binder may be any one or more of the previously described calcium sources and lecithin binders.

The agglomerated calcium source of the present disclosure is a homogenous powder that may be incorporated into a base nutritional powder, such as by dryblending. The base nutritional powder into which the agglomerated calcium source is incorporated may be formulated as any nutritional powder including, but not limited to, an infant nutritional powder, a pediatric nutritional powder, and an adult nutritional powder.

Accordingly, in another aspect of the present disclosure, a nutritional powder is provided. The nutritional powder comprises a base powder comprising one or more of a protein, a fat, and a carbohydrate, and an agglomerated calcium source comprising particles of a calcium source adhered together with a lecithin binder. The agglomerated calcium source may be any one or more of the previously described agglomerated calcium sources. Furthermore, the particles of the calcium source and the lecithin binder used to form the agglomerated calcium source may be any one or more of the previously described calcium sources and lecithin binders.

In embodiments of the nutritional powder of the present disclosure, the base powder comprises a protein, a fat, and a carbohydrate. The nutritional powder may be formulated with sufficient kinds and amounts of nutrients so as to provide a sole, primary, or supplemental source of nutrition for the individual for whom the nutritional powder is intended (i.e., an infant, a toddler, a child or an adult). Generally, the nutritional powder will have a caloric density tailored to the nutritional needs of the ultimate user. In typical instances, the nutritional powder may provide from about 65 kcal/100 g (of nutritional powder) to about 800 kcal/100 g, including from about 90 kcal/100 g to about 550 kcal/100 g, and also including from about 150 kcal/100 g to about 550 kcal/100 g. Other caloric densities are within the scope of the present disclosure.

As mentioned above, the nutritional powder includes a base powder comprising one or more of a protein, a fat, and a carbohydrate. In embodiments of the nutritional powder of the present disclosure, the base powder comprises at least one source of protein, at least one source of carbohydrate, and at least one source of fat. Generally, any source of protein, fat, or carbohydrate that is suitable for use in nutritional products is also suitable for use in the nutritional powder of the present disclosure, provided that such macronutrients are also compatible with the essential elements of the nutritional powder as described herein.

Although total concentrations or amounts of protein, fat, and carbohydrate may vary depending upon the nutritional needs of the particular individual for whom the nutritional powder is formulated, such concentrations or amounts most typically fall within one of the following embodied ranges, inclusive of any other essential protein, fat, or carbohydrate component as described herein.

In embodiments in which the nutritional powder is formulated as an infant nutritional powder, the protein component is typically present in an amount of from about 5% to about 35% by weight of the infant nutritional powder, including from about 10% to about 30%, from about 10% to about 25%, from about 15% to about 25%, from about 20% to about 30%, from about 15% to about 20%, and also including from about 10% to about 16% by weight of the infant nutritional powder. The carbohydrate component is typically present in an amount of from about 40% to about 75% by weight of the infant nutritional powder, including from about 45% to about 75%, from about 45% to about 70%, from about 50% to about 70%, from about 50% to about 65%, from about 50% to about 60%, from about 60% to about 75%, from about 55% to about 65%, and also including from about 65% to about 70% by weight of the infant nutritional powder. The fat component is typically present in an amount of from about 10% to about 40% by weight of the infant nutritional powder, including from about 15% to about 40%, from about 20% to about 35%, from about 20% to about 30%, from about 25% to about 35%, and also including from about 25% to about 30% by weight of the infant nutritional powder.

In embodiments in which the nutritional powder is formulated as a pediatric formula, the protein component is typically present in an amount of from about 5% to about 30% by weight of the pediatric nutritional powder, including from about 10% to about 25%, from about 10% to about 20%, from about 10% to about 15%, from about 15% to about 20%, and also including from about 12% to about 20% by weight of the pediatric nutritional powder. The carbohydrate component is typically present in an amount of from about 40% to about 75% by weight of the pediatric nutritional powder, including from about 45% to about 70%, from about 50% to about 70%, from about 55% to about 70%, and also including from about 55% to about 65% by weight of the pediatric nutritional powder. The fat component is typically present in an amount of from about 10% to about 25% by weight of the pediatric nutritional powder, including from about 12% to about 20%, and also including from about 15% to about 20% by weight of the pediatric nutritional powder.

Additional suitable ranges for proteins, fats, and carbohydrates in those embodiments in which the nutritional powder is formulated as an infant nutritional powder or a pediatric powder, based on a percentage of total calories of the nutritional powder, are set forth in Table 1.

TABLE 1

| | Embodiment A | Embodiment B | Embodiment C |
|---|---|---|---|
| Nutrient | (% Total Calories) | (% Total Calories) | (% Total Calories) |
| Carbohydrate | 1-85 | 30-75 | 35-65 |
| Protein | 2-75 | 5-50 | 7-40 |
| Fat | 5-70 | 20-60 | 25-50 |

Note:
Each numerical value in the table is preceded by the term “about”

In embodiments in which the nutritional powder is formulated as an adult nutritional powder, the protein component is typically present in an amount of from about 5% to about 35% by weight of the adult nutritional powder, including from about 10% to about 30%, from about 10% to about 20%, from about 15% to about 20%, and including from about 20% to about 30% by weight of the adult nutritional powder. The carbohydrate component is typically present in an amount of from about 40% to about 80% by weight of the adult nutritional powder, including from about 50% to about 75%, from about 50% to about 65%, from about 55% to about 70%, and also including from 60% to 75% by weight of the adult nutritional powder. The fat component is typically present in an amount of from about 0.5% to about 20% by weight of the adult nutritional powder, including from about 1% to about 15%, from about 1% to about 10%, from about 1% to about 5%, from about 5% to about 20%, from about 10% to about 20%, and also including from about 15% to about 20% by weight of the adult nutritional powder.

Additional suitable ranges for proteins, fats, and carbohydrates in those embodiments in which the nutritional powder is formulated as an adult nutritional powder, based on a percentage of total calories of the nutritional powder, are set forth in Table 2.

TABLE 2

| | Embodiment D | Embodiment E | Embodiment F |
|---|---|---|---|
| Nutrient | (% Total Calories) | (% Total Calories) | (% Total Calories) |
| Carbohydrate | 1-98 | 0-75 | 20-50 |
| Protein | 1-98 | 5-80 | 15-55 |
| Fat | 1-98 | 20-70 | 25-40 |

Note:
Each numerical value in the table is preceded by the term “about”

In embodiments, the nutritional powder of the present disclosure includes protein or a source of protein. Generally, any source of protein may be used so long as it is suitable for oral nutritional compositions and is otherwise compatible with any other selected ingredients or features in the nutritional powder. Examples of proteins (and sources thereof) suitable for use in the nutritional powder of the present disclosure include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of protein (or sources thereof) suitable for use in the nutritional powder of the present disclosure include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The nutritional powders of the present disclosure may include any individual source of protein or combination of the various sources of protein listed above.

In addition, the proteins used in the nutritional powder disclosed herein can also include, or be entirely or partially replaced by, free amino acids known for use in nutritional products, non-limiting examples of which include L-leucine, L-isoleucine, L-valine, L-tryptophan, L-glutamine, L-tyrosine, L-methionine, L-cysteine, taurine, L-arginine, L-carnitine, and combinations thereof.

In embodiments, the nutritional powders of the present disclosure include a protein component that comprises a hydrolyzed protein. The hydrolyzed protein component may be partially hydrolyzed or extensively hydrolyzed. The term “partially hydrolyzed” refers to proteins having a degree of hydrolysis of 25% or less, including less than 20%, including less than 15%, including less than 10%, and also including proteins having a degree of hydrolysis of less than 5%. The term “extensively hydrolyzed” refers to proteins having a degree of hydrolysis of greater than 25%, including greater than 28%, greater than 30%, greater than 40%, and also including proteins having a degree of hydrolysis of greater than 50%. The degree of hydrolysis is the extent to which peptide bonds are broken by a hydrolysis chemical reaction. To quantify the hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the TECATOR Kjeldahl method. These analytical methods are well known.

In embodiments, the nutritional powder of the present disclosure includes a carbohydrate or a source of carbohydrate. The carbohydrate or source of carbohydrate suitable for use in the nutritional powder of the present disclosure may be simple, complex, or variations or combinations thereof. Generally, the carbohydrate may include any carbohydrate or carbohydrate source that is suitable for use in oral nutritional compositions and is otherwise compatible with any other selected ingredients or features of the nutritional powder.

Examples of carbohydrates (or sources thereof) suitable for use in the nutritional powder of the present disclosure include, but are not limited to, polydextrose, maltodextrin; hydrolyzed or modified starch or cornstarch; glucose polymers; corn syrup; corn syrup solids; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., FIBERSOL^{TM}, a digestion-resistant maltodextrin, comprising soluble dietary fiber); soluble and insoluble fibers derived from fruits or vegetables; other resistant starches; and combinations thereof. The nutritional powders of the present disclosure herein may include any individual source of carbohydrate or combination of the various sources of carbohydrate listed above.

In embodiments, the nutritional powder of the present disclosure includes a fat or a source of fat. The fat or source of fat suitable for use in the nutritional powder of the present disclosure may be derived from various sources including, but not limited to, plants, animals, and combinations thereof. Generally, the fat may include any fat or source of fat that is suitable for use in oral nutritional compositions and is otherwise compatible with any other selected ingredients or features in the nutritional powder. Examples of fat (or sources thereof) suitable for use in the nutritional powder of the present disclosure include, but are not limited to, coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof.

Generally, the fats used in nutritional powders for formulating infant nutritional powders and pediatric nutritional powders provide fatty acids needed both as an energy source and for the healthy development of the infant, toddler, or child. These fats typically comprise triglycerides, although the fats may also comprise diglycerides, monoglycerides, and free fatty acids. Fatty acids provided by the fats in the nutritional powder include, but are not limited to, capric acid, lauric acid, myristic acid, palmitic acid, palmitoleic acid, stearic acid, oleic acid, linoleic acid, alpha-linolenic acid, ARA, EPA, and DHA. The nutritional powders of the present disclosure can include any individual source of fat or combination of the various sources of fat listed above.

In embodiments, the nutritional powder of the present disclosure may further comprise optional ingredients that may modify the physical, chemical, hedonic, or processing characteristics of the nutritional powder or serve as additional nutritional components when used for a targeted population. The optional ingredients may be included in the base powder (i.e., included as ingredients in the formulation to produce the base powder) or may be separate from the base powder (e.g., added as separate ingredients into the base powder after the base powder is produced). Many such optional ingredients are known or otherwise suitable for use in nutritional products and may also be used in the nutritional powder of the present disclosure, provided that such optional ingredients are safe and effective for oral administration and are compatible with the essential and other ingredients in the nutritional powder.

Examples of such optional ingredients include, but are not limited to, preservatives, antioxidants, emulsifying agents, buffers, additional nutrients as described herein, colorants, flavors (natural, artificial, or both), thickening agents, flow agents, anti-caking agents, and stabilizers.

In embodiments, the nutritional powder of the present disclosure further comprises minerals (in addition to the agglomerated calcium source), non-limiting examples of which include phosphorus, magnesium, iron, zinc, manganese, copper, sodium, potassium, molybdenum, chromium, selenium, chloride, and combinations thereof. The minerals may be included in the base powder (i.e., included as ingredients in the formulation to produce the base powder) or may be separate from the base powder (e.g., added as separate ingredients into the base powder after the base powder is produced).

In embodiments, the nutritional powder of the present disclosure further comprises vitamins or related nutrients, non-limiting examples of which include vitamin A, vitamin D, vitamin E, vitamin K, thiamine, riboflavin, pyridoxine, vitamin B12, niacin, folic acid, pantothenic acid, biotin, vitamin C, carotenoids (e.g., lutein, beta-carotene, lycopene, zeaxanthin), choline, inositol, probiotics, nucleotides, nucleosides, salts and derivatives thereof, and combinations thereof. The vitamins or related nutrients may be included in the base powder (i.e., included as ingredients in the formulation to produce the base powder) or may be separate from the base powder (e.g., added as separate ingredients into the base powder after the base powder is produced).

The nutritional powder of the present disclosure is typically in the form of a flowable particulate composition, or at least a particulate composition that can be easily scooped and measured with a spoon or similar other device, wherein the composition can be easily reconstituted by the intended user with a suitable aqueous fluid, typically water, to form a liquid nutritional formula for immediate oral or enteral use. In this context, “immediate” use generally means within about 48 hours, most typically within about 24 hours, preferably right after reconstitution. The quantity of nutritional powder required to produce a volume suitable for one serving may vary.

The nutritional powder of the present disclosure may be packaged and sealed in single or multi-use containers, and then stored under ambient conditions for up to about 36 months or longer, more typically from about 12 to about 24 months. For multi-use containers, these packages can be opened and then covered for repeated use by the user, provided that the covered package is then stored under ambient conditions (e.g., avoid extreme temperatures) and the contents used within about one month or so.

The nutritional powder of the present disclosure may be manufactured by dryblending ingredients comprising an agglomerated calcium source and a base powder. The base powder of the present disclosure may be prepared by any known or otherwise effective technique suitable for making and formulating a nutritional base powder or similar formula. Such techniques and variations thereof for any given formula may be determined and applied by one of ordinary skill in the nutritional powder manufacturing arts.

The base powder of the present disclosure can be prepared by any of a variety of known or otherwise effective formulation or manufacturing methods. These methods typically involve the initial formation of an aqueous slurry containing carbohydrates, proteins, fats, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. This emulsion can then be further diluted, heat-treated, and subsequently dried via spray-drying or the like to produce a base powder. Other suitable methods of producing a nutritional base powder are described, for example, in U.S. Pat. No. 6,365,218 (Borschel et al.), U.S. Pat. No. 6,589,576 (Borschel et al.), U.S. Pat. No. 6,306,908 (Carlson et al.), U.S. Patent Application No. 20030118703 (Nguyen et al.), all of which are hereby incorporated by reference.

Once the base powder has been produced, the agglomerated calcium source is dryblended into the base powder to produce the nutritional powder of the present disclosure. The agglomerated calcium source is introduced into the base powder and thoroughly mixed into the base powder using suitable conventional mixing equipment to produce a homogeneous nutritional powder.

Nutritional powders that include the agglomerated calcium source of the present disclosure exhibit improved flowability and less foam generation (when reconstituted with water or other liquids) as compared to otherwise identical nutritional powders that do not include the agglomerated calcium source. In embodiments of the nutritional powder of the present disclosure, the nutritional powder exhibits an increase in flow factor of 15% to 75% as compared to an otherwise identical nutritional powder that does not include the agglomerated calcium source. In embodiments of the nutritional powder of the present disclosure, the nutritional powder exhibits an increase in flow factor of 25% to 75%, including 35% to 75%, 40% to 75%, 50% to 75%, and also including 60% to 75% as compared to an otherwise identical nutritional powder that does not include the agglomerated calcium source.

In embodiments of the nutritional powder of the present disclosure, reconstitution of the nutritional powder with water yields from 10% to 88% (by volume) less foam as compared to an otherwise identical nutritional powder that does not include the agglomerated calcium source. In embodiments of the nutritional powder of the present disclosure, reconstitution of the nutritional powder with water yields from 20% to 88% less foam (by volume), including from 30% to 88%, from 35% to 88%, from 50% to 88%, from 60% to 88%, and also including from 75% to 88% less foam (by volume) as compared to an otherwise identical nutritional powder that does not include the agglomerated calcium source.

The volume of foam may be measured using a foam test method. In the foam test method, a sample of nutritional powder is weighed in accordance with a recommended reconstitution rate of the nutritional powder (e.g., 130 grams of nutritional powder per liter). A volume of 180 mL of tap water is measured and transferred to an 8 fl. oz. bottle with a reclosable cap. The sample of nutritional powder is added to the surface of the water in the 8 fl. oz. bottle and the cap is placed on the bottle. The capped bottle is then shaken using a mechanical shaker for 5 seconds. The bottle is removed from the mechanical shaker and two-thirds of the bottle's content is immediately poured down the side of a 250 mL cylinder. The remainder of the content of the bottle is swirled by hand so as to capture any remaining foam and is poured down the side of the 250 mL cylinder. The volume of foam (mL) in the 250 mL cylinder is immediately measured and recorded (initial foam measurement). After 30 minutes has elapsed, the volume of foam (mL) is measured again and recorded.

### EXAMPLES

The following examples further describe and demonstrate specific embodiments within the scope of the present disclosure. The examples are for purposes of illustration only and are not intended to limit the scope of the present disclosure.

Example 1—In this Example, 14 samples of embodiments of the agglomerated calcium source of the present disclosure were prepared and their physical properties were compared to a calcium phosphate-tribasic control (Control TCP). To prepare the samples of the agglomerated calcium source, the Control TCP was treated with lecithin binder spray solutions (SS) comprising different lecithins (commercially available from Danisco USA, Inc. (New Century, Kans.)) at different lecithin concentrations (see Table 3) in a fluid bed agglomerator. The fluid bed agglomerator process variables (PV) used to create each sample are shown in Table 4. The theoretical amount of lecithin applied (% by weight) and the estimated amount of lecithin incorporated into each sample of agglomerated calcium source (% by weight) is shown in Table 3, along with the spray solutions (SS) and process variables (PV) used to create each sample of the agglomerated calcium source. Tables 6 to 8 show various physical properties associated with each sample of the agglomerated calcium source and the untreated Control TCP.

TABLE 3
Spray Solutions used to Treat Control TCP

| | | | | | | % |
|---|---|---|---|---|---|---|
| | | | | | Total | Lecithin |
| | | Lecithin | Lecithin | Water | Solution | in |
| | Lecithin Used | HLB | [g] | [g] | [g] | solution |
| SS 1 | Solec ™ E | 12 | 27.5 | 247.5 | 275.0 | 10% |
| SS 2 | Solec ™ E | 12 | 143.2 | 1289.2 | 1432.4 | 10% |
| SS 3 | Solec ™ 152 | 4 | 143.2 | 0.0 | 143.2 | 100% |
| SS 4 | Solec ™ HR-2B | 8 | 143.2 | 1289.2 | 1432.4 | 10% |
| SS 5 | Solec ™ 152.0 | 4 | 174.0 | 0.0 | 174.0 | 100% |
| SS 6 | Solec ™ E | 12 | 309.5 | 1754.6 | 2064.1 | 15% |
| SS 7 | Solec ™ 162-US | 4 | 680.4 | 0.0 | 680.4 | 100% |
| SS 8 | Solec ™ HR-2B | 8 | 1987.1 | 0 | 1987.1 | 100% |
| SS 9 | Solec ™ 162-US | 4 | 726.4 | 0 | 726.4 | 20% |
| SS 10 | Solec ™ 162-US | 4 | 363.2 | 0 | 363.2 | 100% |
| SS 11 | Solec ™ 162-US | 4 | 1089.6 | 0 | 1089.6 | 100% |
| SS 12 | Solec ™ CA | 6 | 363.2 | 0 | 363.2 | 100% |
| SS 13 | Solec ™ CA | 6 | 726.4 | 0 | 726.4 | 100% |
| SS 14 | Solec ™ CA | 6 | 1089.6 | 0 | 1089.6 | 100% |

TABLE 4
Fluid Bed Agglomerator Process Variables

| | Atomizing | Spray | Spray | Product | Inlet Air | |
|---|---|---|---|---|---|---|
| | Air Pressure | Rate | Temperature | Temperature | Temperature | Fluidizing |
| | [bar] | [mL/min] | [° C.] | [° C.] | [° C.] | Air [%] |
| PV 1 | 2 | 30 | 21 | 36 | 110 | 31 |
| PV 2 | 2 | 30 | 21 | 31 | 115 | 30 |
| PV 3 | 3 | 30 | 21 | 22 | 90 | 35 |
| PV 4 | 2 | 30 | 21 | 33 | 118 | 30 |
| PV 5 | 2 | 30 | 21 | 41 | 90 | 40 |
| PV 6 | 2 | 30 | 21 | 30 | 100 | 30 |
| PV 7 | 3 | 30 | 74 | 42 | 115 | 33 |
| PV 8 | 3 | 30 | 37 | 26 | 45 | 30 |
| PV 9 | 3 | 30 | 74 | 30 | 105 | 35 |
| PV 10 | 3 | 30 | 74 | 29 | 101 | 35 |
| PV 11 | 3 | 30 | 74 | 26 | 61 | 35 |
| PV 12 | 3 | 30 | 45 | 26 | 59 | 35 |
| PV 13 | 3 | 30 | 65 | 18 | 23 | 35 |
| PV 14 | 3 | 30 | 74 | 21 | 25 | 35 |

TABLE 5
Process of Manufacturing of Agglomerated Calcium Source

| | | | Theoretical | Estimated Final |
|---|---|---|---|---|
| | SS | PV | Lecithin | Lecithin |
| Sample Number | Used | Used | Applied [%] | incorporated (%) |
| Sample 1 | 1 | 1 | 1 | 1.24 |
| Sample 2 | 2 | 2 | 5 | 6.01 |
| Sample 3 | 3 | 3 | 5 | 5.60 |
| Sample 4 | 4 | 4 | 5 | 5.70 |
| Sample 5 | 5 | 5 | 10 | 10.85 |
| Sample 6 | 6 | 6 | 20 | 27.74 |
| Sample 7 | 7 | 7 | 20 | 21.37 |
| Sample 8 | 9 | 9 | 42.2 | 46.26 |
| Sample 9 | 11 | 11 | 20 | 21.76 |
| Sample 10 | 12 | 12 | 10 | 10.60 |
| Sample 11 | 13 | 13 | 30 | 32.58 |
| Sample 12 | 14 | 14 | 10 | 10.60 |
| Sample 13 | 15 | 15 | 20 | 21.29 |
| Sample 14 | 16 | 16 | 30 | 31.38 |

TABLE 6
Density and Porosity Values

| | Loose Bulk | Vibrated Bulk | Skeletal | |
|---|---|---|---|---|
| | Density | Density | Density | Porosity |
| Sample Number | (g/cc) | (g/cc) | (g/cc) | (%) |
| Sample 1 | 0.361 | NDDML | 2.886 | 87.5 |
| Sample 2 | 0.405 | NDDML | 2.727 | 85.2 |
| Sample 3 | 0.358 | NDDML | 2.765 | 87.1 |
| Sample 4 | 0.440 | NDDML | 2.735 | 83.9 |
| Sample 5 | 0.445 | 0.520 | 2.514 | 82.3 |
| Sample 6 | 0.446 | NDDML | 2.489 | 82.1 |
| Sample 7 | 0.527 | 0.649 | 2.108 | 75.0 |
| Sample 8 | 0.655 | 0.742 | 1.698 | 61.4 |
| Sample 9 | 0.555 | NDDML | 2.188 | 74.6 |
| Sample 10 | 0.474 | NDDML | 2.504 | 81.1 |
| Sample 11 | 0.630 | NDDML | 1.894 | 66.7 |
| Sample 12 | 0.424 | NDDML | 2.537 | 83.3 |
| Sample 13 | 0.494 | NDDML | 2.205 | 77.6 |
| Sample 14 | 0.570 | NDDML | 1.922 | 70.3 |
| Control TCP | 0.178 | 0.256 | 3.025 | 94.1 |

NDDML = not determined due to method limits.

TABLE 7
Water Activity, Flow Factor, and Color Values

| Sample | Water | Moisture | Flow | Powder Hunter Color | | |
|---|---|---|---|---|---|---|
| Number | Activity | (%) | Factor | a | b | L |
| Sample 1 | 0.1887 | 1.54 | 2.33 | −0.41 | 1.93 | 97.47 |
| Sample 2 | 0.2280 | 1.255 | 2.38 | −0.46 | 2.69 | 97.21 |
| Sample 3 | 0.2677 | 1.485 | 2.17 | −0.44 | 2.9 | 97.79 |
| Sample 4 | 0.3403 | 1.5 | 2.33 | −0.54 | 2.91 | 97.95 |
| Sample 5 | 0.2367 | 1.25 | 1.82 | −0.63 | 4.76 | 97.23 |
| Sample 6 | 0.6178 | 1.68 | ND | −1.22 | 6.64 | 97.09 |
| Sample 7 | 0.1449 | 0.95 | 1.82 | −0.06 | 5.8 | 94.42 |
| Sample 8 | 0.1526 | 0.805 | 2.94 | −2.57 | 24.74 | 89.67 |
| Sample 9 | 0.2200 | 1.28% | 1.92 | 0.11 | 6.06 | 94.45 |
| Sample 10 | 0.2058 | 1.24% | 1.75 | 0.08 | 4.14 | 95.71 |
| Sample 11 | 0.2955 | 1.33% | 1.92 | 0.13 | 6.28 | 93.83 |
| Sample 12 | 0.2810 | 1.54% | 1.79 | −0.13 | 4.09 | 95.63 |
| Sample 13 | 0.4064 | 1.85% | 1.92 | −0.24 | 6.17 | 94.37 |
| Sample 14 | 0.3633 | 1.68% | 1.92 | −0.39 | 8.05 | 93.34 |
| Control TCP | 0.2594 | 1.395 | 1.49 | −0.12 | 0.47 | 98.57 |

TABLE 8
Particle Size and Morphology Values

| | Particle Size | | | | | | | | Particle |
|---|---|---|---|---|---|---|---|---|---|
| Sample | ×10 | ×16 | ×50 | ×84 | ×90 | ×99 | Mean | | Morphology |
| Number | (μm) | (μm) | (μm) | (μm) | (μm) | (μm) | (μm) | Span | Circularity |
| Sample 1 | 0.77 | 1.07 | 3.20 | 10.28 | 14.35 | 29.84 | 5.59 | 4.24 | 0.712 |
| Sample 2 | 0.65 | 0.87 | 2.51 | 9.31 | 13.36 | 29.54 | 5.00 | 5.06 | 0.745 |
| Sample 3 | 0.72 | 0.99 | 2.93 | 10.50 | 14.79 | 30.50 | 5.57 | 4.80 | 0.743 |
| Sample 4 | 0.66 | 0.90 | 2.63 | 9.66 | 13.74 | 29.81 | 5.15 | 4.97 | 0.691 |
| Sample 5 | 0.68 | 0.94 | 3.12 | 12.49 | 16.88 | 30.19 | 6.16 | 5.19 | 0.748 |
| Sample 6 | 0.60 | 0.82 | 2.56 | 9.50 | 13.58 | 29.87 | 5.07 | 5.07 | 0.755 |
| Sample 7 | 0.62 | 0.87 | 3.07 | 14.06 | 19.38 | 37.09 | 6.80 | 6.11 | 0.786 |
| Sample 8 | 0.94 | 1.44 | 7.27 | 27.91 | 33.58 | 49.91 | 12.81 | 4.49 | 0.891 |
| Sample 9 | 0.65 | 0.92 | 3.31 | 16.02 | 21.44 | 39.00 | 7.43 | 6.28 | 0.744 |
| Sample 10 | 0.71 | 1.01 | 3.37 | 12.91 | 18.75 | 41.50 | 6.85 | 5.35 | 0.734 |
| Sample 11 | 0.59 | 0.82 | 2.83 | 13.21 | 19.05 | 41.63 | 6.67 | 6.52 | 0.806 |
| Sample 12 | 0.71 | 1.00 | 3.13 | 12.08 | 17.81 | 41.06 | 6.51 | 5.46 | 0.739 |
| Sample 13 | 0.62 | 0.84 | 2.52 | 13.50 | 19.53 | 37.49 | 6.38 | 7.50 | 0.737 |
| Sample 14 | 0.60 | 0.84 | 2.97 | 15.49 | 21.42 | 39.96 | 7.19 | 7.01 | 0.723 |
| Control TCP | 0.70 | 0.97 | 2.58 | 5.03 | 5.91 | 9.57 | 3.01 | 2.02 | 0.737 |

As can be appreciated from Tables 6 to 8, the samples of the agglomerated calcium source have unique physical characteristics as compared to the Control TCP. Overall, the agglomerated calcium source has a higher loose bulk density (ranging from 101% to 268% higher), a lower skeletal density (ranging from 4.5% to 43.9% lower), a lower porosity (ranging from 7% to 34.8% lower), a larger particle size (ranging from 66% to 325.5% higher), a higher polydispersity (as shown by an increase in span of 110% to 202.6%), and decreased circularity (up to 20% decrease) as compared to the Control TCP. The particle size values were determined using laser diffraction techniques, and morphology values were determined using a Malvern Morphologi G3 particle characterization system, which measures the size and shape of particles via static image analysis.

In addition, the samples of the agglomerated calcium source exhibit less white, more green color, and more yellow color (depending on the extent of lecithin application) as compared to the Control TCP (e.g., ΔL (“L value” of Sample minus “L value” of Control TCP) ranging from −0.62 to −8.9, Aa (“a value” of Sample minus “a value” of Control TCP) ranging from −0.29 to −2.45, and Ab (“b value” of Sample minus “b value” of Control TCP) ranging from 1.46 to 24.27). The color values were determined using the Hunter Color L, a, b method.

Furthermore, the samples of the agglomerated calcium source flow better than the Control TCP as shown by the increase in flow factor (i.e., about 21.8% to about 97% increase in flow factor). The flow factor values were determined using the Brookfield Powder Flow test mentioned herein.

Example 2—In this Example, 14 samples of a nutritional powder containing the agglomerated calcium source of the present disclosure were prepared and their physical properties were compared to base powders (Base Powder 1 and Base Powder 2) and a control nutritional powder containing a base powder (Base Powder 1) dry blended with calcium phosphate-tribasic (Control Powder). To prepare the sample nutritional powders, an agglomerated calcium source (one of Samples 1 to 14 of Example 1) was dry blended with a base powder (Base Powder 1 or Base Powder 2). The base powders were prepared using conventional manufacturing techniques.

The base powders did not include any added calcium ingredients (other than calcium inherently present in another ingredient, such as a protein source) or lecithin.

As seen in Table 9, Powder 1 comprised Base Powder 1 dry blended with Sample 1 of the agglomerated calcium source of Example 1, Powder 2 comprised Base Powder 1 dry blended with Sample 2 of the agglomerated calcium source of Example 1, and so on. Similarly, the Control Powder comprised Base Powder 1 dry blended with calcium phosphate-tribasic (i.e., Control TCP from Example 1). Tables 10 to 14 show various physical properties associated with Powders 1 to 14, Base Powder 1, Base Powder 2, and the Control Powder.

TABLE 9
Formulation of Nutritional Powders

| | | | Final TCP | Final Lecithin |
|---|---|---|---|---|
| Nutritional | | | Concentration | Concentration |
| Powder | Base Powder | Calcium Source | (%) | (%) |
| Powder 1 | Base Powder 1 | Sample 1 | 0.8 | 0.01 |
| Powder 2 | Base Powder 1 | Sample 2 | 0.8 | 0.04 |
| Powder 3 | Base Powder 1 | Sample 3 | 0.8 | 0.04 |
| Powder 4 | Base Powder 1 | Sample 4 | 0.8 | 0.04 |
| Powder 5 | Base Powder 1 | Sample 5 | 0.8 | 0.09 |
| Powder 6 | Base Powder 1 | Sample 6 | 0.8 | 0.20 |
| Powder 7 | Base Powder 1 | Sample 7 | 0.8 | 0.20 |
| Powder 8 | Base Powder 1 | Sample 8 | 0.8 | 0.58 |
| Powder 9 | Base Powder 2 | Sample 9 | 0.8 | 0.20 |
| Powder 10 | Base Powder 2 | Sample 10 | 0.8 | 0.09 |
| Powder 11 | Base Powder 2 | Sample 11 | 0.8 | 0.34 |
| Powder 12 | Base Powder 2 | Sample 12 | 0.8 | 0.09 |
| Powder 13 | Base Powder 2 | Sample 13 | 0.8 | 0.20 |
| Powder 14 | Base Powder 2 | Sample 14 | 0.8 | 0.34 |
| Control Powder | Base Powder 1 | Control TCP | 0.8 | 0 |
| Base Powder 1 | N/A | No Calcium Added | 0 | 0 |
| Base Powder 2 | N/A | No Calcium Added | 0 | 0 |

TABLE 10
Density and Porosity Values

| Nutritional | Loose Bulk | Vibrated Bulk | Skeletal Density | Porosity |
|---|---|---|---|---|
| Powder | Density (g/cc) | Density (g/cc) | (g/cc) | (%) |
| Powder 1 | 0.328 | 0.454 | 1.161 | 71.75 |
| Powder 2 | 0.320 | 0.446 | 1.163 | 72.49 |
| Powder 3 | 0.329 | 0.462 | 1.163 | 71.70 |
| Powder 4 | 0.331 | 0.451 | 1.160 | 71.54 |
| Powder 5 | 0.332 | 0.470 | 1.162 | 71.42 |
| Powder 6 | 0.333 | 0.448 | 1.159 | 71.35 |
| Powder 7 | 0.332 | 0.456 | 1.157 | 71.39 |
| Powder 8 | 0.363 | 0.480 | 1.139 | 68.13 |
| Powder 9 | 0.359 | 0.430 | 1.147 | 62.52 |
| Powder 10 | 0.369 | 0.431 | 1.153 | 62.60 |
| Powder 11 | 0.364 | 0.425 | 1.147 | 62.94 |
| Powder 12 | 0.371 | 0.438 | 1.152 | 61.99 |
| Powder 13 | 0.366 | 0.448 | 1.153 | 61.13 |
| Powder 14 | 0.360 | 0.427 | 1.150 | 62.87 |
| Control | 0.328 | 0.453 | 1.160 | 71.72 |
| Powder | | | | |
| Base | 0.335 | 0.464 | 1.147 | 68.95 |
| Powder 1 | | | | |
| Base | 0.343 | 0.423 | 1.149 | 63.18 |
| Powder 2 | | | | |

TABLE 11
Water Activity, Flow Factor, and Color Values

| Nutritional | Water | Moisture | Flow | Powder Hunter Color | | |
|---|---|---|---|---|---|---|
| Powder | Activity | (%) | Factor | a | b | L |
| Powder 1 | 0.221 | 2.33 | 6.67 | −1.68 | 17.78 | 90.33 |
| Powder 2 | 0.225 | 2.27 | 5.00 | −2.01 | 18.46 | 90.37 |
| Powder 3 | 0.236 | 2.39 | 5.26 | −1.98 | 18.17 | 90.40 |
| Powder 4 | 0.240 | 2.32 | 5.26 | −2.08 | 18.17 | 90.51 |
| Powder 5 | 0.236 | 2.29 | 4.55 | −2.11 | 18.34 | 90.43 |
| Powder 6 | 0.305 | 2.40 | 5.88 | −1.85 | 17.99 | 90.35 |
| Powder 7 | 0.224 | 2.30 | 6.25 | −2.04 | 18.38 | 90.27 |
| Powder 8 | 0.167 | 2.16 | 5.26 | −0.94 | 18.85 | 90.04 |
| Powder 9 | 0.187 | 1.97 | 6.25 | −0.97 | 18.35 | 88.54 |
| Powder 10 | 0.196 | 2.07 | 5.88 | −0.70 | 17.86 | 88.47 |
| Powder 11 | 0.198 | 2.01 | 6.25 | −0.73 | 18.25 | 88.23 |
| Powder 12 | 0.207 | 2.14 | 6.25 | −0.99 | 18.39 | 88.44 |
| Powder 13 | 0.186 | 1.97 | 5.88 | −0.96 | 18.33 | 88.42 |
| Powder 14 | 0.199 | 2.08 | 5.88 | −0.74 | 18.08 | 88.29 |
| Control Powder | 0.215 | 2.23 | 7.14 | −2.09 | 18.30 | 90.64 |
| Base Powder 1 | 0.227 | 2.31 | 3.85 | −2.02 | 18.87 | 90.05 |
| Base Powder 2 | 0.192 | 1.90 | 4.17 | −0.74 | 18.10 | 88.25 |

TABLE 12
Particle Size and Morphology Values

| | Particle Size | | | | | | | Particle |
|---|---|---|---|---|---|---|---|---|
| Nutritional | ×10 | ×50 | ×84 | ×90 | ×99 | Mean | | Morphology |
| Powder | (μm) | (μm) | (μm) | (μm) | (μm) | (μm) | Span | Circularity |
| Powder 1 | 21.22 | 122.87 | 240.04 | 278.68 | 410.43 | 138.27 | 2.10 | 0.856 |
| Powder 2 | 21.00 | 121.55 | 236.89 | 274.95 | 404.45 | 136.54 | 2.09 | 0.848 |
| Powder 3 | 21.14 | 121.77 | 239.92 | 279.41 | 414.32 | 137.95 | 2.12 | 0.858 |
| Powder 4 | 20.85 | 120.70 | 236.84 | 275.08 | 404.25 | 136.07 | 2.11 | 0.843 |
| Powder 5 | 20.83 | 115.85 | 226.21 | 261.70 | 393.48 | 130.58 | 2.08 | 0.875 |
| Powder 6 | 20.43 | 112.36 | 225.80 | 263.63 | 400.00 | 129.23 | 2.16 | 0.977 |
| Powder 7 | 22.30 | 121.09 | 236.79 | 275.21 | 404.80 | 136.70 | 2.09 | 0.871 |
| Powder 8 | 26.93 | 127.78 | 237.34 | 274.41 | 402.93 | 141.16 | 1.94 | 0.842 |
| Powder 9 | 23.55 | 119.62 | 224.87 | 260.31 | 395.53 | 133.27 | 1.98 | 0.874 |
| Powder 10 | 21.29 | 114.31 | 213.3 | 245.04 | 357.12 | 126.12 | 1.96 | 0.883 |
| Powder 11 | 23.78 | 118.71 | 221.73 | 255.59 | 390.17 | 131.88 | 1.95 | 0.874 |
| Powder 12 | 21.13 | 114.31 | 216.72 | 249.94 | 387.13 | 127.9 | 2.00 | 0.877 |
| Powder 13 | 23.17 | 118.64 | 221.85 | 255.31 | 387.58 | 131.59 | 1.96 | 0.862 |
| Powder 14 | 23.24 | 117.47 | 216.59 | 247.96 | 370.18 | 129.28 | 1.91 | 0.856 |
| Control | 21.35 | 119.16 | 231.59 | 268.31 | 399.12 | 133.88 | 2.07 | 0.824 |
| Powder | | | | | | | | |
| Base | 22.56 | 119.03 | 229.51 | 265.39 | 395.79 | 133.45 | 2.04 | 0.844 |
| Powder 1 | | | | | | | | |
| Base | 24.37 | 118.46 | 218.97 | 251.13 | 384.74 | 131.03 | 1.91 | 0.843 |
| Powder 2 | | | | | | | | |

TABLE 13
Wettability, Dispersibility, Slide Grain, and Color Values of
Reconstituted Powders

| | | | | Reconstituted | | |
|---|---|---|---|---|---|---|
| Nutritional | Wettability | | Slide | Hunter Color | | |
| Powder | (seconds) | Dispersibility | Grain | a | b | L |
| Powder 1 | 120 | 3.5 | 6 | −1.62 | 13.46 | 85.37 |
| Powder 2 | 120 | 3.5 | 6 | −1.54 | 13.44 | 85.52 |
| Powder 3 | 120 | 3.5 | 6 | −1.59 | 13.47 | 85.44 |
| Powder 4 | 120 | 3.5 | 6 | −1.52 | 13.69 | 85.35 |
| Powder 5 | 120 | 3.5 | 6 | −1.63 | 13.69 | 85.30 |
| Powder 6 | 120 | 3.5 | 6 | −1.56 | 13.67 | 85.25 |
| Powder 7 | 120 | 3.5 | 6 | −1.56 | 13.82 | 84.57 |
| Powder 8 | 120 | 5 | 6 | −0.24 | 13.29 | 85.77 |
| Powder 9 | 120 | 2 | 2 | 0.02 | 12.97 | 84.5 |
| Powder 10 | 120 | 2 | 2 | 0.02 | 12.88 | 84.5 |
| Powder 11 | 120 | 2 | 2 | 0.00 | 13.03 | 84.47 |
| Powder 12 | 120 | 2 | 2 | 0.07 | 12.81 | 84.53 |
| Powder 13 | 120 | 2 | 2 | −0.01 | 12.98 | 84.02 |
| Powder 14 | 120 | 2 | 2 | −0.01 | 12.97 | 84.51 |
| Control Powder | 120 | 3.5 | 6 | −1.77 | 13.51 | 85.22 |
| Base Powder 1 | 120 | 3.5 | 6 | −1.79 | 13.59 | 85.10 |
| Base Powder 2 | 120 | 2 | 2 | 0.18 | 12.87 | 84.46 |

TABLE 14
pH, Separation, and Foam of Reconstituted Nutritional Powders

| | pH of | | | | |
|---|---|---|---|---|---|
| | Reconstituted | | | Foam | |
| Nutritional | Nutritional | Separation | | Initial | After 30 |
| Powder | Powder | Bottom | Top | (mL) | min (mL) |
| Powder 1 | 6.73 | 0 | 38 | 10 | 8 |
| Powder 2 | 6.74 | 0 | 38 | 6 | 4 |
| Powder 3 | 6.74 | 0 | 36 | 4 | 4 |
| Powder 4 | 6.74 | 0 | 38 | 4 | 2 |
| Powder 5 | 6.75 | 0 | 38 | 2 | 2 |
| Powder 6 | 6.74 | 0 | 36 | 3 | 2 |
| Powder 7 | 6.73 | 0 | 38 | 2 | 2 |
| Powder 8 | 6.63 | 0 | 30 | 2 | 2 |
| Powder 9 | 6.86 | ND | ND | 14 | 14 |
| Powder 10 | 6.85 | ND | ND | 4 | 6 |
| Powder 11 | 6.85 | ND | ND | 8 | 8 |
| Powder 12 | 6.85 | ND | ND | 4 | 6 |
| Powder 13 | 6.85 | ND | ND | 6 | 6 |
| Powder 14 | 6.85 | ND | ND | 6 | 6 |
| Control Powder | 6.74 | 0 | 36 | 14 | 10 |
| Base Powder 1 | 6.74 | 0 | 34 | 16 | 10 |
| Base Powder 2 | 6.84 | ND | ND | 22 | 18 |

ND = not determined

As can be appreciated from Tables 10 to 14, Powders 1 to 14 containing an agglomerated calcium source have unique physical characteristics as compared to the base powders, which are otherwise identical except that they do not contain an agglomerated calcium source. Overall, Powders 1 to 14 flow better than Base Powder 1 and Base Powder 2, as shown by the increase in flow factor (i.e., about 15% to about 75% increase in flow factor, see Table 11). The flow factor values were determined using the Brookfield Powder Flow test mentioned herein.

In addition, Powders 1 to 14 generally produced less foam (both initial and after 30 minutes) as compared to Base Powder 1 and Base Powder 2 (i.e., about 10% to about 88% less foam, see Table 14). The foam values were determined in accordance with the foam test method described herein.

In terms of other physicochemical characteristics, Powders 1 to 14 had similar values as compared to Base Powder 1 and Base Powder 2.

Unless otherwise indicated herein, all sub-embodiments and optional embodiments are respective sub-embodiments and optional embodiments to all embodiments described herein. While the present disclosure has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the present disclosure, in its broader aspects, is not limited to the specific details, the representative compositions or formulations, and illustrative examples shown and described. Accordingly, departures may be made from such details without departing from the spirit or scope of Applicant's general disclosure herein.

1. A nutritional ingredient comprising an agglomerated calcium source, wherein the agglomerated calcium source comprises particles of a calcium source adhered together with a lecithin binder.

2. The nutritional ingredient of claim 1, wherein the calcium source is selected from tricalcium phosphate, calcium citrate, calcium phosphate, dicalcium phosphate, calcium carbonate, and combinations thereof.

3. The nutritional ingredient of claim 1, wherein the lecithin binder comprises a lecithin having a hydrophilic-lipophilic balance (HLB) of about 4 to about 12.

4. The nutritional ingredient of any one of claim 1, wherein the calcium source comprises tricalcium phosphate and the lecithin binder comprises a lecithin having an HLB of about 4 to about 12.

5. The nutritional ingredient of any one of claim 1, wherein the agglomerated calcium source comprises from 55 wt % to 99.5 wt % particles of the calcium source and from 0.5 wt % to 40 wt % lecithin binder.

6. The nutritional ingredient of claim 1, wherein the agglomerated calcium source has a mean particle size of 4.95 μm to 30 μm.

7. The nutritional ingredient of claim 1, wherein the agglomerated calcium source has an x90 particle size of 10 μm to 50 μm.

8. The nutritional ingredient of claim 1, wherein the agglomerated calcium source has a flow factor of 1.7 to 4.

9. The nutritional ingredient of claim 1, wherein the agglomerated calcium source has a loose bulk density of 0.35 g/cm³ to 0.7 g/cm³.

10. The nutritional ingredient of claim 1, wherein the agglomerated calcium source has a skeletal density of 1.4 g/cm³ to 3 g/cm³.

11. A nutritional powder comprising:
a base powder comprising one or more of a protein, a fat, and a carbohydrate; and
an agglomerated calcium source comprising particles of a calcium source adhered together with a lecithin binder.

12. The nutritional powder of claim 11, wherein the calcium source is selected from tricalcium phosphate, calcium citrate, calcium phosphate, dicalcium phosphate, calcium carbonate, and combinations thereof.

13. The nutritional powder of claim 11, wherein the lecithin binder comprises a lecithin having an HLB of about 4 to about 12.

14. The nutritional powder of claim 11, wherein the calcium source is tricalcium phosphate and the lecithin binder comprises a lecithin having an HLB of about 4 to about 12.

15. The nutritional powder of claim 11, wherein the agglomerated calcium source comprises from 55 wt % to 99.5 wt % particles of the calcium source and from 0.5 wt % to 40 wt % lecithin binder.

16. The nutritional powder of claim 11, wherein the agglomerated calcium source comprises from 0.1 wt % to 3 wt % of the nutritional powder, based on the total weight of the nutritional powder.

17. The nutritional powder of claim 11, wherein upon reconstitution with water, the nutritional powder yields from 10% to 88% less foam as compared to an otherwise identical nutritional powder that does not include the agglomerated calcium source.

18. The nutritional powder of claim 11, wherein the nutritional powder exhibits an increase in flow factor of 15% to 75% as compared to an otherwise identical nutritional powder that does not include the agglomerated calcium source.
